(19) United States
(12) Patent Application Publication
(10) Pub. No.: US 2016/0234906 A1
(43) Pub. Date: Aug. 11, 2016

(54) LIGHTING SYSTEM AND METHOD FOR CONTROLLING LIGHTING SYSTEM

(71) Applicant: Panasonic Intellectual Property Management Co., Ltd., Osaka (JP)

(72) Inventor: Yuto HIDAKA, Osaka (JP)

(21) Appl. No.: 15/012,134

(22) Filed: Feb. 1, 2016

(30) Foreign Application Priority Data
Feb. 10, 2015 (JP) 2015-024581

(51) Int. Cl. H05B 33/08; H05B 37/02

(52) U.S. Cl. CPC H05B 33/0854; H05B 37/0227; H05B 37/0218; H05B 37/0281

(57) ABSTRACT

A lighting system includes: a plurality of lighting devices; a plurality of lighting controllers; and a system controller. The system controller includes: a timer; a schedule storage; a first communication circuit; and an instruction controller which causes the first communication circuit to transmit control information which includes an instruction associated with a time indicated by a counter value and at least one address. Each of the lighting controllers include: a sensor; a second communication circuit; an address storage; and a dimming controller which switches to one of modes that is indicated in the control information from another of the modes and executes the one of the modes, if the address indicated in the control information matches the own address. The modes include a human detection mode, a brightness detection mode, and a dimming level fixed mode.

### CROSS REFERENCE TO RELATED APPLICATION

This application claims the benefit of priority of Japanese Patent Application Number 2015-024581 filed on Feb. 10, 2015, the entire content of which is hereby incorporated by reference.

### BACKGROUND

1. Technical Field

The present disclosure relates to a lighting system which controls dimming of a lighting device.

2. Description of the Related Art

Conventionally, a lighting system has been known which controls a dimming level of a lighting device such as an LED light on the ceiling.

For example, according to a dimming control system disclosed in Japanese Unexamined Patent Application Publication No. 2004-349065, a dimming-control parent device transmits, to a dimming-control terminal, a control-target value for adjusting the amount of light emitted from a lighting device. The dimming control parent device stores an operation schedule in which a control-target value and a time to start the control are associated with one another, and transmits the control-target value to the dimming control terminal when the current time comes to the start time.

### SUMMARY

According to the above conventional technique, the amount of light emitted from a lighting device is adjusted in accordance with a preset schedule such that the illuminance of a lighting device at a certain time approximates to a control-target value for that time.

For example, from the viewpoint of energy saving, however, the amount of light emitted from the lighting device may be changed or maintained according to not only the current time, but environment items appropriately selected from among various environmental items.

In a lighting system which provides a comparatively large area with illumination light using a plurality of lighting devices, environment light may have different influences on subregions, for example. In this case, a problem arises as to how dimming of the plurality of lighting devices needs to be controlled.

In view of the above conventional problem, the present disclosure describes, in one general aspect, a lighting system which can appropriately dim a plurality of lighting devices and a method for controlling the lighting system, according to the environment where the plurality of lighting devices are installed.

A lighting system according to an aspect of the present disclosure is a lighting system including: a plurality of lighting devices each including a light source and a lighting circuit which causes the light source to provide illumination; a plurality of lighting controllers each of which controls dimming of one or more lighting devices among the plurality of lighting devices by controlling the lighting circuit included in each of the one or more lighting devices; and a system controller which controls the plurality of lighting controllers. The system controller includes: a timer which outputs a counter value indicating a time; a schedule storage for storing schedule information which includes an instruction directed to the plurality of lighting controllers and a time associated with the instruction; a first communication circuit which transmits information to the plurality of lighting controllers; and an instruction controller which identifies, from the schedule information, an instruction associated with the time indicated by the counter value, and causes the first communication circuit to transmit control information which includes the identified instruction and an address assigned to at least one lighting controller among the plurality of lighting controllers. Each of the plurality of lighting controllers includes: a sensor which detects (i) a person in a space where the one or more lighting devices, the dimming of which is controlled by the each of the plurality of lighting controllers, are disposed, and (ii) brightness of the space; a second communication circuit which receives the control information transmitted from the system controller; an address storage which stores an own address of the each of the plurality of lighting controllers that is an address assigned to the each of the plurality of lighting controllers; and a dimming controller which switches to one of modes that is indicated in the control information from another of the modes and executes the one of the modes, if the address indicated in the control information received by the second communication circuit matches the own address, the modes including (a) a human detection mode for controlling the dimming in accordance with a result of human detection by the sensor, (b) a brightness detection mode for controlling the dimming in accordance with a result of detection of the brightness by the sensor, and (c) a dimming level fixed mode for controlling the dimming by maintaining a dimming level at a fixed value.

A method for controlling a lighting system according to an aspect of the present disclosure is a method for controlling a lighting system which includes: a plurality of lighting controllers each of which controls dimming of one or more lighting devices; and a system controller which controls the plurality of lighting controllers. The system controller includes: a timer which outputs a counter value indicating a time; and a schedule storage for storing schedule information which includes an instruction directed to the plurality of lighting controllers and a time associated with the instruction. Each of the plurality of lighting controllers includes: an address storage which stores an own address of the each of the plurality of lighting controllers that is an address assigned to the each of the plurality of lighting controllers; and a sensor which detects a person in a space where the one or more lighting devices are disposed, and brightness of the space. The method includes: identifying, by the system controller from the schedule information, an instruction associated with the time indicated by the counter value; transmitting, to the plurality of lighting controllers by the system controller, control information which includes the identified instruction and an address assigned to at least one lighting controller among the plurality of lighting controllers; receiving, by each of the plurality of lighting controllers, the control information transmitted from the system controller; and switching, by each of the plurality of lighting controllers, to one of modes that is indicated in the control information from another of the modes, and executing, by the lighting controller, the one of the modes, if the address indicated in the control information matches the own address, the modes including (a) a human detection mode for controlling the dimming in accordance with a result of human detection by the sensor, (b) a brightness detection mode for controlling the dimming in accordance with a result of detection of the brightness by the sensor, and (c) a dimming level fixed mode for controlling the dimming by maintaining a dimming level at a fixed value.

The lighting system according to an aspect of the present disclosure can appropriately dim a plurality of lighting devices according to the environment where the plurality of lighting devices are installed.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1A illustrates a schematic configuration of a lighting system according to an embodiment;

FIG. 1B illustrates a schematic configuration of a subsystem according to the embodiment;

FIG. 2 is a block diagram illustrating a functional configuration of the lighting system according to the embodiment;

FIG. 3 is a sequence diagram illustrating a flow of basic operation of the lighting system according to the embodiment;

FIG. 4 illustrates an example of schedule information according to the embodiment;

FIG. 5 is a first diagram illustrating an example of a flow of operation of a lighting control device according to the embodiment;

FIG. 6 is a second diagram illustrating an example of a flow of operation of the lighting control device according to the embodiment;

FIG. 7 illustrates an example of schedule information and an example of parameter information according to Variation 1 of the embodiment;

FIG. 8 illustrates an example of schedule information and an example of time-of-day information according to Variation 2 of the embodiment;

FIG. 9 illustrates a system control device and a communication terminal according to Variation 3 of the embodiment;

FIG. 10 illustrates an example of a lighting system setting screen displayed by the communication terminal according to Variation 3 of the embodiment;

FIG. 11 illustrates a system control device and a communication terminal according to Variation 4 of the embodiment;

FIG. 12 illustrates an example of a schedule confirmation screen displayed by the communication terminal according to Variation 4 of the embodiment;

FIG. 13 illustrates a lighting control device and a communication terminal according to Variation 5 of the embodiment;

FIG. 14 illustrates an example of a mode confirmation screen displayed by the communication terminal according to Variation 5 of the embodiment; and

FIG. 15 illustrates a flow of instruction information in a subsystem according to Variation 5 of the embodiment.

### DETAILED DESCRIPTION OF THE EMBODIMENTS

The following describes a lighting system according to an embodiment and variations with reference to the drawings. Note that the embodiment and variations described below each show a specific example of the present disclosure. The numerical values, shapes, materials, constituent elements, the arrangement and connection of the constituent elements, and others indicated in the following embodiment and variations thereof are mere examples, and therefore do not intend to limit the inventive concept. Therefore, among the constituent elements in the following embodiment and variations thereof, constituent elements not recited in any of the independent claims defining the most generic part of the inventive concept are described as arbitrary constituent elements.

Note that the drawings are schematic diagrams, and do not necessarily provide strictly accurate illustration. In the drawings, the same numeral is given to the substantially same configuration, and a redundant description thereof may be omitted or simplified.

### Embodiment

The following describes a lighting system according to an embodiment.

### [Configuration of Lighting System]

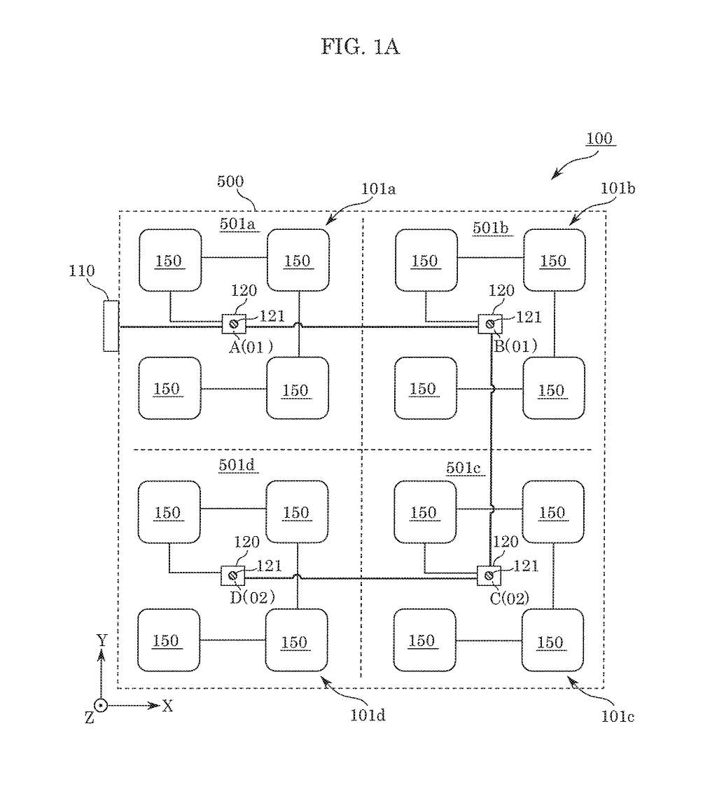

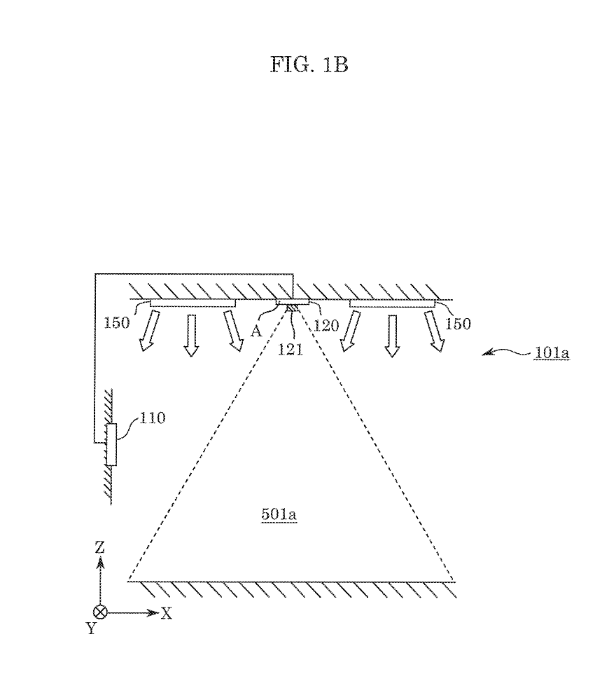

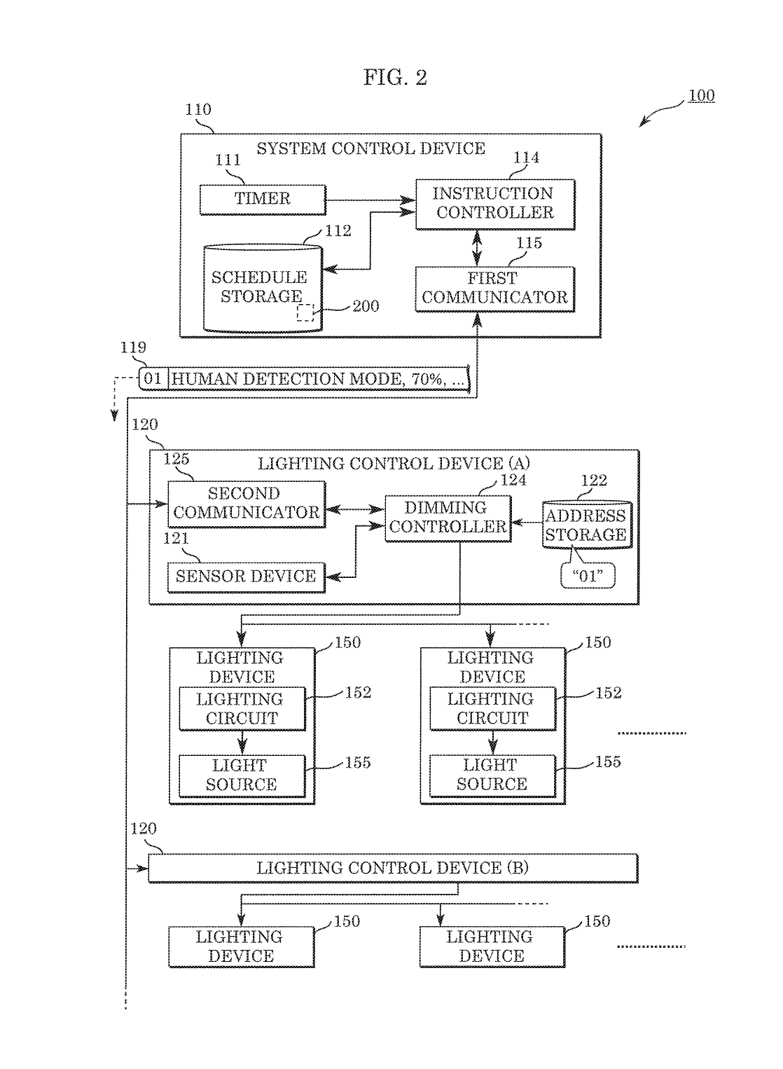

The first describes a configuration of a lighting system according to an embodiment with reference to FIGS. 1A, 1B, and 2.

FIG. 1A illustrates a schematic configuration of lighting system 100 according to the embodiment, and FIG. 1B illustrates a schematic configuration of subsystem 101a according to the embodiment.

Specifically, FIG. 1A is a top view illustrating an example of the layout of constituent elements of lighting system 100, and FIG. 1B is a side view of subsystem 101a which is a part of lighting system 100. Note that depictions of the lines that connect lighting control device 120 and lighting devices 150 are omitted from FIG. 1B.

While lighting system 100 is installed in a space (room) which needs lighting such as, for example, a room in an office building, depiction of objects which may be present in the space, such as fixtures and persons, are omitted from FIGS. 1A and 1B.

FIG. 2 is a block diagram illustrating a functional configuration of lighting system 100 according to the embodiment.

As illustrated in these drawings, lighting system 100 according to the embodiment includes plural lighting devices 150, plural lighting control devices 120, and system control device 110.

Specifically, in the present embodiment, lighting system 100 includes four subsystems (101a to 101d) each of which includes one lighting control device 120 and four lighting devices 150.

Here, although FIG. 1A illustrates lighting system 100 which includes four lighting control devices 120 labeled with A to D, (hereinafter, each may also be referred to as “lighting control device A (B, C, or D)”), at least two lighting control devices 120 may be included in lighting system 100. In other words, lighting system 100 may include two or more subsystems each including one lighting control device 120 and one or more lighting devices 150. Note that in FIG. 1A, “01” and “02” in the parentheses shown aside A to D are examples of addresses assigned to lighting control devices 120.

Furthermore, subsystems 101b to 101d each have the same configuration as that of subsystem 101a, and thus a detailed description of subsystems 101b to 101d is omitted in the following.

Lighting device 150 includes light source 155 and lighting circuit 152 which causes light source 155 to provide illumination.

Lighting device 150 is a ceiling light which includes, for example, a light-emitting device serving as light source 155, which has one or more light emitting diodes (LEDs). In this case, lighting circuit 152 is a drive circuit (light circuit) which controls operation of the light-emitting device, such as turning on and off and dimming the light-emitting device, for example.

System control device 110 controls plural lighting control devices 120. System control device 110 includes timer 111 which outputs a counter value indicating a time, schedule storage 112 for storing schedule information 200, first communicator 115 which transmits information to plural lighting control devices 120, and instruction controller 114.

Schedule information 200 includes an instruction directed to plural lighting control devices 120 and a time associated with the instructions. An example of schedule information 200 will be described below with reference to FIG. 4.

Instruction controller 114 identifies, from schedule information 200, an instruction associated with the time indicated by a counter value output from timer 111. Instruction controller 114 further causes first communicator 115 to transmit control information 119 which includes the identified instruction and an address assigned to at least one of plural lighting control devices 120. Subsequently, plural lighting control devices 120 receive control information 119, and at least one lighting control device 120 having the assigned address performs operation in accordance with control information 119.

Note that in the present embodiment, system control device 110 is disposed on the wall of a room, as illustrated in FIG. 1B. In this case, system control device 110 may include, for example, a switch for tuning on and off the power for the whole of lighting system 100, a button for generating or updating schedule information 200, and a display panel for showing the state of lighting system 100.

In the present embodiment, for example, system control device 110 which is a device called an operation panel is disposed, and schedule information 200 is generated or updated through user operation on the above button, for instance. Note that schedule information 200 may be generated or updated using information from a communication terminal such as a smartphone. A description of this aspect is later given as Variation 3.

The place where system control device 110 is disposed is not particularly limited, and system control device 110 may be disposed at a place where people cannot see, such as the roof-space, for example. In this case, for example, system control device 110 can receive various instructions from a user through wireless or cable communication between first communicator 115 and a remote control or a mobile terminal, for instance.

Lighting control device 120 controls dimming of one or more lighting devices 150 by controlling lighting circuit 152 included in each of one or more lighting devices 150. For example, lighting control device 120 gives an instruction about a dimming level to lighting circuit 152, thus performing control (dimming control) for causing lighting device 150 to provide illumination at the dimming level.

Note that a dimming level is a type of a variable for adjusting the brightness of a light, and the brightness of the light increases with an increase in the numerical value of the variable (the maximum value is 100%). Furthermore, the dimming level can also be represented as a “dimming degree” or a “dimming ratio”, for example.

For example, if lighting control device 120 gives an instruction indicating a dimming level of “100%” to lighting device 150, lighting control device 120 transmits instruction information corresponding to a dimming level of “100%” to lighting device 150. In accordance with the instruction information, lighting circuit 152 of lighting device 150 controls light source 155 to set the optical output of light source 155 to the maximum output.

Note that lighting circuit 152 controls the optical output of light source 155 according to a pulse width modulation (PWM) signal, for example. However, a technique used for this control is not particularly limited, and dimming of lighting device 150 may be controlled according to a digital signal.

For example, if light source 155 includes a plurality of light emitters such as a plurality of electric bulbs, dimming of light source 155 may be controlled by changing the number of light emitters to be turned on, among the light emitters.

According to the present embodiment, lighting control device 120 is connected with four lighting devices 150 via signal lines (see FIG. 1A), and lighting control device 120 transmits a signal (instruction information) indicating a dimming level through the signal lines, thus causing four lighting devices 150 to provide illumination at the dimming level.

More specifically, lighting control device 120 includes sensor device 121, address storage 122 which stores an own address of the lighting control device that is an address assigned to lighting control device 120, second communicator 125 which receives control information 119, and dimming controller 124.

Sensor device 121 detects a person in a space where one or more lighting devices 150 are disposed dimming of which is controlled, and brightness of the space. Sensor device 121 includes an imaging device in the present embodiment, and detects a person and brightness from image data obtained through imaging by the imaging device.

For example, sensor device 121 images a target indoor space using a solid state image sensor such as a complementary metal-oxide semiconductor (CMOS) image sensor, and detects a person and brightness from image data obtained as a result of the imaging.

Note that the configuration of sensor device 121 is not particularly limited, and sensor device 121 may include two physically separate sensors, namely a human sensing sensor which detects a person and an illuminance sensor which detects brightness, for example.

Dimming controller 124 has features of controlling dimming in various modes including a mode in which a result of detection by sensor device 121 is used, and switching between these modes according to an instruction from system control device 110.

Specifically, if the address indicated in control information 119 received by second communicator 125 matches the own address stored in address storage 122, dimming controller 124 performs the following operation. Dimming controller 124 switches to one of modes, which is indicated in control information 119 received by second communicator 125, from another of the modes and executes the one of the modes, the modes including (a) a human detection mode for controlling dimming in accordance with a result of human detection by sensor device 121, (b) a brightness detection mode for controlling dimming in accordance with a result of brightness detection by sensor device 121, and (c) a dimming level fixed mode for controlling dimming by maintaining a dimming level at a fixed value.

Note that if the address indicated in control information 119 does not match the own address, dimming controller 124 ignores the instruction included in control information 119.

In the present embodiment, as illustrated in FIG. 1A, address “01” is assigned to lighting control devices A and B, and address “02” is assigned to lighting control devices C and D. In this case, as illustrated in FIG. 2, when address “01” is included in control information 119, lighting control devices A and B operate in accordance with the instruction indicated in control information 119, such as the “human detection mode”, whereas lighting control devices C and D ignore the instruction included in control information 119.

Note that lighting control devices 120 (A and B) to which address “01” is assigned are examples of a first lighting control device, and lighting control devices 120 (C and D) to which address “02” is assigned are examples of a second lighting control device.

Accordingly, dimming controller 124 has a function of switching between modes according to times, such as a mode focusing on the presence of a person, a mode focusing on the detected brightness, and a mode intended to maintain a predetermined dimming level, when controlling dimming to change the brightness of one or more lighting devices 150.

Here, illumination region 500 indicated by the dotted rectangle in FIG. 1A is an area to which illumination light is supplied from 16 lighting devices 150 included in lighting system 100. In the present embodiment, illumination region 500 can be defined as an internal area of a room where four subsystems (101a to 101d) are disposed on the ceiling.

Illumination region 500 is divided into subregions (501a to 501d) corresponding to four subsystems (101a to 101d). For example, subregion 501a is treated as a space where one or more lighting devices 150 (four lighting devices 150 in the present embodiment) are disposed, dimming of which is controlled by lighting control device A included in subsystem 101a.

For example, natural light coming in from a window in the wall of the room falls on illumination region 500, and thus the brightness of illumination region 500 also depends on, for example, the weather, in addition to the dimming level of each of plural lighting devices 150.

In the present embodiment, subregions 501a and 501b in the upper portion of FIG. 1A are on the window side, whereas subregions 501c and 501d in the lower portion of the drawing are on the corridor side. Accordingly, the brightness of subregions 501a and 501b is likely to be influenced by natural light such as sunlight.

Note that the layout of lighting system 100 illustrated in FIG. 1A and the layout of subsystem 101a illustrated in FIG. 1B are examples, and different layouts may be used. For example, sensor device 121 may be disposed in one of lighting devices 150 in subsystem 101a. In this case, lighting control device 120 except sensor device 121, namely, the body part of lighting control device 120, may be disposed in the ceiling space or on the wall of a room, for example. In other words, sensor device 121 and the body part of lighting control device 120 may be physically separate.

Furthermore, system control device 110 and one of lighting control devices 120 may be achieved as a single device. For example, system control device 110 and one of lighting control devices 120 may be accommodated in an operation panel disposed on the wall. For example, system control device 110 and one of lighting control devices 120 may be accommodated in the body of one of lighting devices 150.

Furthermore, various functions of system control device 110 and lighting control device 120 according to the present embodiment may be achieved by software, such as a program executed on a computer which includes, for instance, a central processing unit (CPU), random access memory (RAM), read only memory (ROM), a communication interface, an I/O port, and a hard disk, or may be achieved by hardware such as an electronic circuit. In the present disclosure, these may be collectively referred to as controller or a control circuit.

### [Example of Operation of Lighting System]

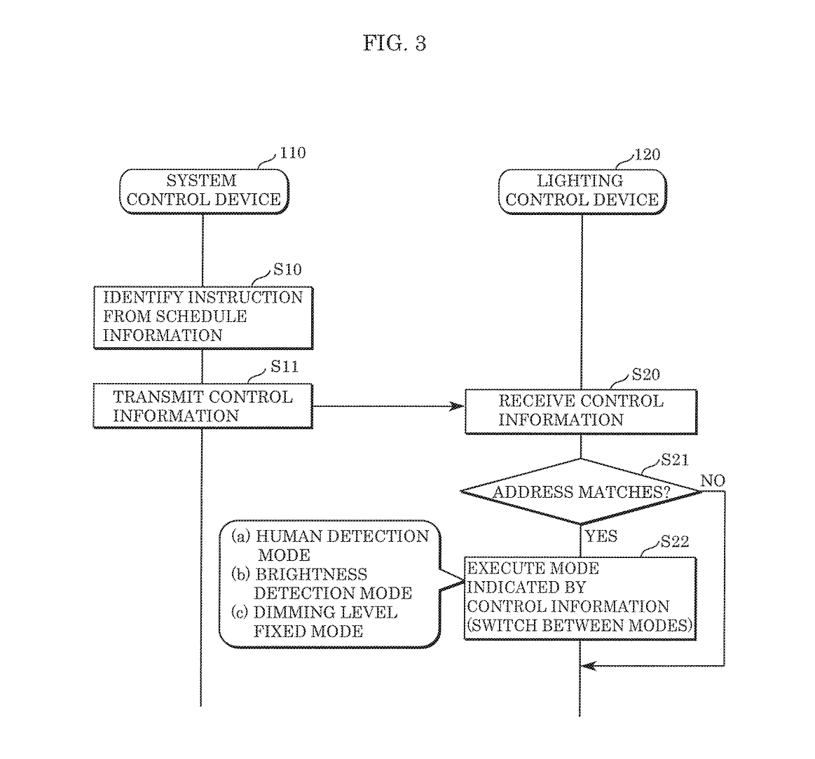

A description of operation of lighting system 100 having the above configuration is given with reference to FIGS. 3 to 6.

The first describes the flow of basic operation of lighting system 100 with reference to FIGS. 3 and 4.

FIG. 3 is a sequence diagram illustrating the flow of basic operation of lighting system 100 according to the embodiment. Note that lighting control devices A to D (see FIG. 1A) each perform the basic operation of lighting control devices 120 illustrated in FIG. 3.

FIG. 4 illustrates an example of schedule information 200 according to the embodiment.

System control device 110 identifies, from schedule information 200, an instruction associated with a time indicated by a counter value output from timer 111 (S10).

For example, instruction controller 114 obtains counter values output from timer 111 at predetermined intervals, and compares a time indicated by an obtained counter value with times to switch between modes (5:00, 10:00, 17:00, and 22:00 in the case of FIG. 4) indicated in schedule information 200 read from schedule storage 112.

Note that in the present embodiment, schedule information 200 read by instruction controller 114 includes first schedule information 201 and second schedule information 202. First schedule information 201 is associated with address “01”, and second schedule information 202 is associated with address “02.” In other words, in the present embodiment, first schedule information 201 includes an instruction directed to lighting control devices A and B, and a time associated with the instruction. Second schedule information 202 includes an instruction directed to lighting control devices C and D, and a time associated with the instruction.

If the result of the above comparison shows that a time indicated by the obtained counter value matches one of the times to switch between modes, or the obtained counter value indicates a time later than one of the times to switch between modes for the first time within a day (from 0:00 until next 0:00), instruction controller 114 identifies an instruction associated with the time to switch between modes from schedule information 200.

For example, if the counter value obtained by instruction controller 114 indicates “5:00”, instruction controller 114 identifies, from both of first schedule information 201 and second schedule information 202, “human detection mode” (see FIG. 4) as the instruction to be given to plural lighting control devices 120.

As illustrated in FIG. 4, in the present embodiment, first schedule information 201 and second schedule information 202 include dimming levels in the human detection mode for when a person is detected and for when no person is detected. Instruction controller 114 identifies parameters indicating “70%” and “5%” which are dimming levels for address “01” and “100%” and “20%” which are dimming levels for address “02.”

System control device 110 further transmits control information 119 which includes the identified instruction to plural lighting control devices 120 (S11).

Specifically, instruction controller 114 causes first communicator 115 to transmit control information 119 which includes address “01” and the instruction (“human detection mode”, “70%”, and “5%”) identified as described above. Furthermore, instruction controller 114 causes first communicator 115 to transmit control information 119 which includes address “02” and the instruction (“human detection mode”, “100%”, and “20%”) identified as described above.

Lighting control device 120 receives control information 119 transmitted from system control device 110 (S20).

Specifically, second communicator 125 receives control information 119, and delivers received control information 119 to dimming controller 124.

Lighting control device 120 determines whether the address indicated in control information 119 matches the own address stored in address storage 122 (S21). If the result of this determination shows that the address indicated in control information 119 matches the own address (YES in S21), lighting control device 120 switches to one of modes which is indicated in control information 119 from another of the modes and executes the one of the modes, the modes including the human detection mode, the brightness detection mode, and the dimming level fixed mode (S22).

If the address indicated in control information 119 does not match the own address (NO in S21), lighting control device 120 does not switch between modes, and continuously executes the mode being executed at the time.

As described above, system control device 110 transmits control information 119 to plural lighting control devices 120 each having an address, at a timing in accordance with schedule information 200. Control information 119 includes the address(es) of one or more lighting control devices 120 which are to operate in accordance with the instruction indicated in control information 119.

In this manner, each of plural lighting control devices 120 can switch between dimming control modes at a timing in accordance with schedule information 200.

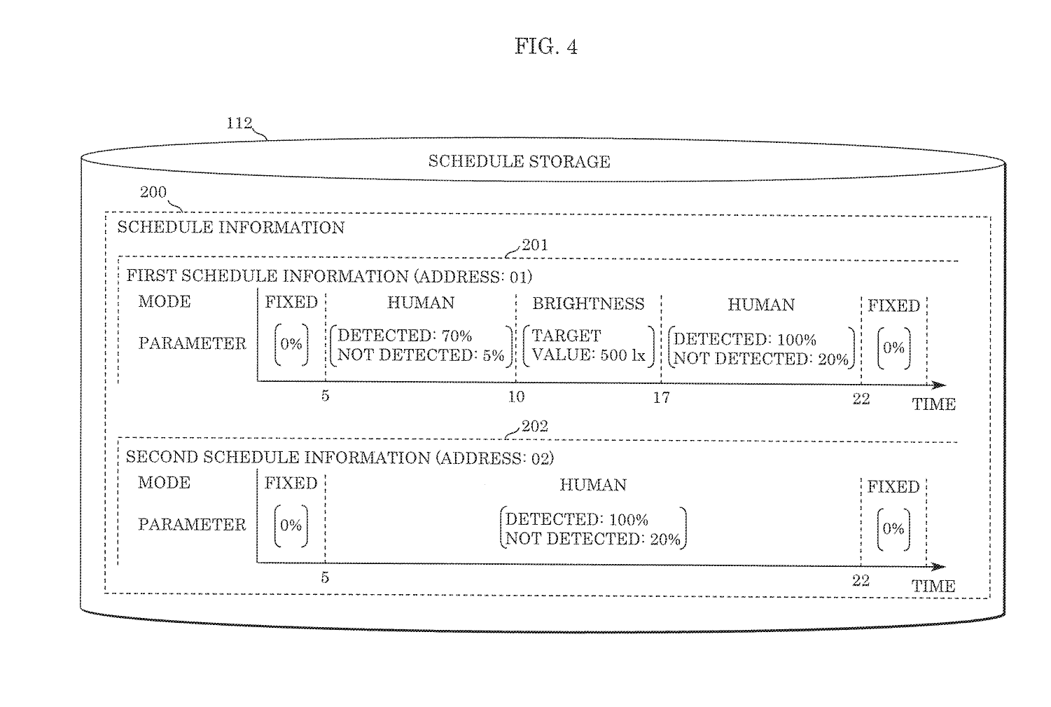

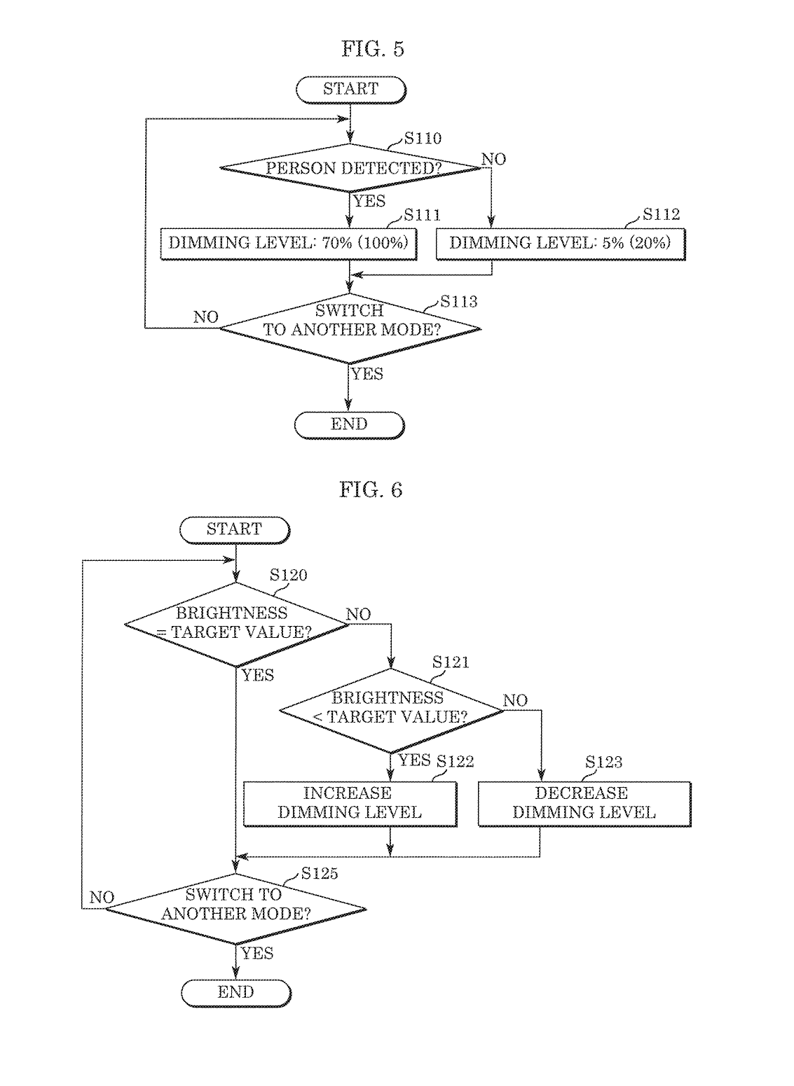

The following describes an example of operation of lighting control device 120, with reference to FIGS. 5 and 6.

FIG. 5 is a first drawing illustrating an example of a flow of operation of lighting control device 120 according to the embodiment, and FIG. 6 is a second drawing illustrating an example of a flow of operation of lighting control device 120 according to the embodiment.

Specifically, FIG. 5 illustrates a processing procedure when lighting control device 120 executes the human detection mode, and FIG. 6 illustrates a processing procedure when lighting control device 120 executes the brightness detection mode. Furthermore, operations illustrated in FIGS. 5 and 6 can be executed by each of four lighting control devices 120 (A to D) according to the present embodiment independently from other lighting control devices 120.

The following description of FIG. 5 focuses on an example of operation performed when lighting control devices 120 (A and B) to which address “01” is assigned receive control information 119 which includes address “01” and an instruction (“human detection mode”, “70%”, and “5%”).

If received control information 119 which includes the own address indicates the human detection mode, lighting control device 120 changes the dimming level of one or more lighting devices 150 (four lighting devices 150 in the present embodiment), according to a result of human detection by sensor device 121.

Specifically, as illustrated in FIG. 5, if a result of detection by sensor device 121 indicates that a person is detected (YES in S110), dimming controller 124 of lighting control device 120 transmits, to four lighting devices 150, a signal (instruction information) for causing the lighting devices to provide illumination at a dimming level of “70%” (S111).

Consequently, four lighting devices 150 each cause light source 155 to provide illumination at a dimming level of “70%.”

Further, if a result of detection by sensor device 121 does not indicate that a person is detected (NO in S110), or in other words, the result indicates that no person is detected, dimming controller 124 transmits, to four lighting devices 150, a signal (instruction information) for causing the lighting devices to provide illumination at a dimming level of “5%” (S112).

Consequently, four lighting devices 150 each cause light source 155 to provide illumination at a dimming level of “5%.”

Note that the above operation differs from operation performed when lighting control devices 120 (C and D) to which address “02” is assigned receive control information 119 which includes address “02” and an instruction (“human detection mode”, “100%”, and “20%”), in the following respect. Specifically, if a result of detection by sensor device 121 indicates that a person is detected (YES in S110), dimming controllers 124 of lighting control devices 120 each transmit, to four lighting devices 150, a signal (instruction information) for causing the lighting devices to provide illumination at a dimming level of “100%” (S111). In contrast, if a result of detection by sensor device 121 does not indicate that a person is detected (NO in S110), dimming controllers 124 each transmit, to four lighting devices 150, a signal (instruction information) for causing the lighting devices to provide illumination at a dimming level of “20%” (S112).

As described above, lighting control devices 120 according to the present embodiment each perform control for changing the dimming level of one or more lighting devices 150 to two levels in the human detection mode, according to whether a person is detected or not detected. If lighting control device 120 does not make a switch to another mode (NO in S113), lighting control device 120 controls dimming in the human detection mode continuously. After that, if control information 119 received by second communicator 125 of lighting control device 120 indicates another mode, lighting control device 120 switches the operation to the other mode (YES in S113).

For example, when the time becomes 10:00 a.m., system control device 110 identifies “brightness detection mode” (see FIG. 4) from first schedule information 201 associated with address “01” and included in schedule information 200.

System control device 110 transmits control information 119 indicating address “01” and an instruction indicating the “brightness detection mode” to lighting control devices 120. Control information 119 also includes, as a parameter which is a part of the instruction, information indicating “500 lx” that is a target value of brightness, for example (see S10 and S11 in FIG. 3, and FIG. 4).

As a result, lighting control devices 120 (A and B) each having address “01” as the own address switch the dimming control mode from the human detection mode to the brightness detection mode.

In this case, lighting control devices 120 each change the dimming level of one or more lighting devices 150, according to the result of brightness detection by sensor device 121.

Specifically, as illustrated in FIG. 6, if the brightness shown by the detection result of sensor device 121 (illuminance in the present embodiment) does not match the target value “500 lx” (NO in S120), the dimming level is changed according to a magnitude relation between the brightness shown by the detection result and the target value “500 lx.”

In other words, if the brightness shown by the detection result is lower than the target value “500 lx” (YES in S121), dimming controller 124 controls four lighting devices 150 to increase the dimming level (S122). For example, if the dimming level indicated in the most previous instruction given to four lighting devices 150 is 70%, dimming controller 124 transmits a signal (instruction information) to four lighting devices 150 in order to cause the lighting devices to provide illumination at a dimming level higher than 70% (for example, 75%).

If the brightness shown by the detection result is higher than the target value “500 lx” (NO in S121), dimming controller 124 controls four lighting devices 150 to lower the dimming level of the lighting devices (S123). For example, if the dimming level indicated in the most previous instruction given to four lighting devices 150 is 70%, dimming controller 124 transmits a signal (instruction information) to four lighting devices 150 to cause the lighting devices to provide illumination at a dimming level lower than 70% (for example, 65%).

Note that lighting control devices 120 (C and D) to which address “02” is assigned receive control information 119, but ignore the instruction such as the “brightness detection mode”, which is included in control information 119, since address “02” is not included in control information 119. Thus, even after 10:00 a.m., lighting control devices 120 (C and D) continuously execute the “human detection mode.”

As described above, lighting control devices 120 according to the present embodiment each detect brightness of a space where one or more lighting devices 150 under control are disposed, and perform control for changing the dimming level of one or more lighting devices 150 in the brightness detection mode to make the detected brightness approximate to the target value. If lighting control device 120 does not make a switch to another mode (NO in S125), lighting control device 120 controls dimming in the brightness detection mode continuously.

After that, if control information 119 received by second communicator 125 of lighting control device 120 indicates another mode, lighting control device 120 switches the operation to the other mode (YES in S125).

For example, when the time becomes 5:00 p.m. (17:00), system control device 110 transmits, to plural lighting control devices 120, control information 119 which includes address “01” and an instruction (“human detection mode”, “100%”, and “20%”) (see S10 and S11 in FIG. 3 and FIG. 4).

As a result, lighting control devices 120 (A and B) each having address “01” as the own address switch the dimming control mode from the brightness detection mode to the human detection mode. In this case, lighting control devices 120 each change the dimming level of four lighting devices 150 according to the result of human detection by sensor device 121. Specifically, when a person is detected, the dimming level of each lighting device 150 is controlled so as to be “100%”, whereas when no person is detected, the dimming level of each lighting device 150 is controlled so as to be “20%.”

After that, when the time becomes 10:00 p.m. (22:00), for example, system control device 110 transmits, to plural lighting control devices 120, control information 119 indicating address “01” and the “dimming level fixed mode.” Furthermore, system control device 110 transmits, to plural lighting control devices 120, control information 119 indicating address “01” and an instruction which indicates the “dimming level fixed mode.” Control information 119 includes, as a parameter which is a part of the instruction, information indicating a dimming level of “0%”, for example (see S10 and S11 in FIG. 3 and FIG. 4).

Note that as described above, if a common instruction is to be given to plural lighting control devices 120 having addresses, system control device 110 may transmit, to plural lighting control devices 120, control information 119 which includes the addresses as the destination addresses.

Plural lighting control devices 120 (A to D) operate in accordance with an instruction indicated in control information 119, since received control information 119 includes “01” and “02” which are the own addresses. Specifically, dimming controllers 124 of lighting control devices 120 each transmit, to four lighting devices 150, a signal (instruction information) for causing the lighting devices to provide illumination at a dimming level of “0%.” In other words, lighting control devices 120 each transmit instruction information to four lighting devices 150 to turn off the lighting devices, and four lighting devices 150 each turn off light source 155, according to the instruction information.

Note that in the operation illustrated in FIG. 6, dimming controller 124 does not need to determine whether the brightness shown by the result of detection by sensor device 121 is exactly the same as the target value. For example, if the brightness shown by the detection result is in a range plus and minus several percent (for example, 5%) from the target value, dimming controller 124 may determine that the brightness shown by the detection result matches the target value (YES in S120).

In such a case, dimming controller 124 may determine in a similar manner whether (a value indicating) the brightness shown by the detection result is lower than the target value (S121). In other words, if the brightness shown by the detection result is lower than, for example, a value that is 95% of the target value, dimming controller 124 may determine that (the value indicating) the brightness is lower than the target value (YES in S121).

Feedback control (S120, S121, S122, S123) for thus making the brightness shown by the detection result fall within a predetermined range which includes a target value is an example of dimming control for making the brightness indicated by the detection result approximate to the target value.

As described above, lighting system 100 according to the present embodiment includes plural lighting devices 150, plural lighting control devices 120 each of which controls dimming of one or more lighting devices 150, and system control device 110 which controls plural lighting control devices 120.

System control device 110 identifies an instruction to be given to at least one lighting control device 120 from the time indicated by the counter value of timer 111 and schedule information 200. System control device 110 further transmits, to plural lighting control devices 120, control information 119 which includes the address of at least one lighting control device 120 and the identified instruction.

Lighting control devices 120 each include sensor device 121 which detects a person in a space where one or more lighting devices 150 are disposed dimming of which is controlled, and brightness of the space, second communicator 125 which receives control information 119, dimming controller 124, and address storage 122 which stores an own address.

If the address indicated in control information 119 received by second communicator 125 matches the own address, dimming controller 124 switches between dimming control modes in accordance with the instruction indicated in control information 119. Specifically, dimming controller 124 switches to one of modes, which is indicated in control information 119, from another of the modes and executes the one of the modes, the modes including the human detection mode, the brightness detection mode, and the dimming level fixed mode.

In this manner, system control device 110 can control plural lighting control devices 120 independently from one another such that dimming is controlled in different modes for times of day, for example.

During the morning, lighting control devices 120 each control dimming of one or more lighting devices 150 in the human detection mode which focuses on whether a person is present, for example. Thus, if a person is present in a target space (one of subregions 501a to 501d), lighting control devices 120 can brightly illuminate an area where the person moves by making the dimming level of one or more lighting devices 150 comparatively high. Furthermore, if a person is not present, minimum brightness, which is determined taking into consideration a possibility of a person coming into the space, for example, can be secured by making the dimming level of one or more lighting devices 150 comparatively low, while keeping power consumption low.

For example, two lighting control devices 120 (A and B) on the window side control dimming of one or more lighting devices 150, during the daytime, in the brightness detection mode which is an operation mode focusing on the brightness. In other words, the dimming level of one or more lighting devices 150 is adjusted to maintain, for example, appropriate brightness for human activity, taking into consideration the environment light at the place where one or more lighting devices 150 under control are installed.

In this manner, for example, in a state where sunlight coming in from a window maintains sufficient brightness, the dimming level of plural lighting devices 150 for a space on the window side (subregions 501a and 501b) is made comparatively low even if a person is present in the space. As a result, power consumption of lighting system 100 can be kept low.

Furthermore, during the daytime, two lighting control devices 120 (C and D) on the corridor side control dimming of one or more lighting devices 150 in the human detection mode continuously from the morning. In this manner, for example, in a space (subregions 501c and 501d) which is comparatively far from the window and thus is assumed to be difficult to maintain sufficient brightness with sunlight, lighting control devices 120 control dimming of plural lighting devices 150 according to whether a person is present. In other words, this achieves effective dimming control of plural lighting devices 150 and reduction in power consumption.

During the night, lighting control devices 120 each control dimming of lighting devices 150 in the dimming level fixed mode intended to maintain a predetermined dimming level. For example, assuming that no person is present, lighting control devices 120 operate to maintain the dimming level of lighting devices 150 at “0%.”

In this manner, lighting system 100 according to the present embodiment changes or maintains the dimming level of one or more lighting devices 150 according to an environmental item appropriately selected for each of time-series sections from among various environmental items (such as whether a person is present, brightness, and use condition of a target space).

Specifically, the dimming control mode of each of plural lighting control devices 120 can be switched to another mode in accordance with a preset schedule.

Accordingly, lighting system 100 can appropriately dim plural lighting devices 150 included in lighting system 100 according to the environment where lighting devices 150 are installed.

In the present embodiment, schedule information 200 includes first schedule information 201 and second schedule information 202. First schedule information 201 includes an instruction directed to at least one lighting control device 120 (first lighting control device), and a time associated with the instruction. Second schedule information 202 includes an instruction directed to at least one lighting control device 120 (second lighting control device) to which a different address from the address of the first lighting control device is assigned, and a time associated with the instruction.

If instruction controller 114 identifies, from first schedule information 201, an instruction associated with the time indicated by the counter value of timer 111, instruction controller 114 causes first communicator 115 to transmit control information 119 which includes the identified instruction and the address assigned to the first lighting control device.

Furthermore, if instruction controller 114 identifies, from second schedule information 202, an instruction associated with the time indicated by the counter value of timer 111, instruction controller 114 causes first communicator 115 to transmit control information 119 which includes the identified instruction and the address assigned to the second lighting control device.

In other words, schedule information 200 according to the present embodiment includes information which indicates associations of times and instructions directed to different addresses. This allows timings of switching between modes to be readily edited or updated for each of plural lighting control devices 120 each associated with one of the addresses, for example.

Furthermore, in the present embodiment, instruction controller 114 causes first communicator 115 to transmit, if the identified instruction indicates the human detection mode, control information 119 which includes parameters indicating dimming levels for the human detection mode for when a person is detected and for when no person is detected. If the address indicated in control information 119 matches the own address and control information 119 indicates the human detection mode, dimming controller 124 controls dimming, using a dimming level indicated by a parameter according to the result of human detection by sensor device 121.

In this manner, even if dimming controller 124 controls dimming in the “human detection mode” during both the morning and night, dimming controller 124 can adjust the dimming level for when a person is detected during the nighttime to, for example, a value greater than the dimming level for when a person is detected during the morning.

In other words, in the human detection mode which focuses on whether a person is present, dimming can be controlled more precisely, taking into consideration the amount of light coming in from a window, for example.

In the present embodiment, if the identified instruction indicates the brightness detection mode, instruction controller 114 causes first communicator 115 to transmit control information 119 which includes a parameter indicating a target value representing target brightness. If the address indicated in control information 119 matches the own address and control information 119 indicates the brightness detection mode, dimming controller 124 controls dimming to make the brightness which is detected by sensor device 121 approximate to the target value indicated by the parameter.

In this manner, for example, if lighting system 100 is installed in a space where precise operations are performed, the target value is set to a comparatively large value, thus maintaining the brightness of the space suitable for the precise operations.

Lighting system 100 according to the embodiment may have a configuration for controlling dimming of plural lighting devices 150 other than the configuration described with reference to FIGS. 1A to 6. The following describes variations of lighting system 100, focusing on differences in configuration from the above-described embodiment.

### Variation 1

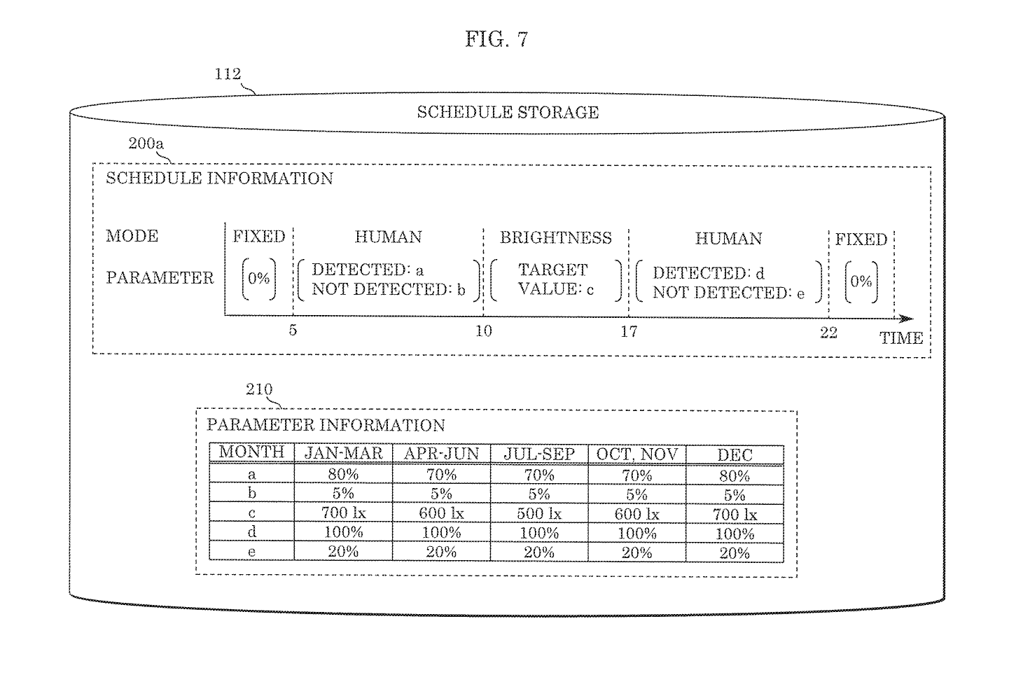

FIG. 7 illustrates an example of schedule information 200a and an example of parameter information 210 according to Variation 1 of the embodiment.

In schedule information 200a illustrated in FIG. 7, parameters for the human detection mode and the brightness detection mode are designated by symbols (a to e), and parameter information 210 includes parameters (numerical values) corresponding to the symbols.

Note that schedule information 200a according to this variation is associated with at least one of addresses “01” and “02.” For example, if schedule information 200a is associated with address “01”, schedule information (not illustrated) associated with address “02” is further stored in schedule storage 112. The same also applies to schedule information 200b according to Variation 2 described below.

Parameter information 210 indicates parameters associated with periods. Specifically, parameter information 210 indicates various parameters associated with periods in units of month, such as a period from January to March.

In this variation, timer 111 of system control device 110 outputs a counter value indicating a time and at least day and month of a date. For example, timer 111 outputs a counter value which includes a date and a time (for example, “2015.01.30, 12:58”).

Instruction controller 114 of system control device 110 reads, from parameter information 210, a parameter associated with a period which includes at least one of month and day indicated by a counter value, and causes first communicator 115 to transmit control information 119 which includes the read parameter.

For example, when a counter value output from timer 111 indicates “2015.01.30, 10:00”, instruction controller 114 reads the “brightness mode” and “target value: c” associated with time “10:00” from schedule information 200a. Instruction controller 114 further reads, from parameter information 210, parameter “700 lx” associated with “January” which is the month indicated by the counter value and “target value: c” read from schedule information 200a.

Instruction controller 114 causes first communicator 115 to transmit control information 119 which includes the instruction identified as described above (“brightness detection mode” and “700 lx”), and one or more addresses associated with schedule information 200a.

Second communicator 125 of each of lighting control devices 120 receives control information 119 transmitted from first communicator 115. As a result, one or more lighting control devices 120 each having an own address that matches one of one or more addresses indicated in control information 119 perform operation as follows. Specifically, dimming controller 124 controls dimming of four lighting devices 150 to make the brightness which is detected by sensor device 121 approximate to the target value “700 lx” (see FIG. 6).

As described above, system control device 110 has schedule information 200a designating a mode for each time of day, and parameter information 210 designating a parameter for use in each mode for each period. In this manner, for example, system control device 110 can provide, for each season for the same mode, lighting control device 120 with a parameter suitable for the season.

For example, parameter information 210 illustrated in FIG. 7 shows that a dimming level for when a person is detected is “80%” in a period from December to March next year (winter period), and is “70%” in a period from April to November (spring to autumn period), in the human detection mode executed during the morning.

In other words, in the spring to autumn period when the sun rises earlier than winter, securing brightness necessary for human activity and reduction in power consumption can be both achieved by making the dimming level for when a person is detected in this period lower than the dimming level for the winter period.

In this manner, lighting system 100 according to this variation can more precisely adjust dimming control parameters which are given to lighting control devices 120, according to, for example, a change in natural environment, thus saving more energy, for example.

Note that although the dimming level for the dimming level fixed mode is fixed at “0%” in FIG. 7, parameter information 210 may define, also for the dimming level designated in the dimming level fixed mode, different values for periods as with parameters for other modes.

Furthermore, time-series sections in parameter information 210 may not be in units of month, and may be in units of day, units of year, or units of day of week.

In first schedule information 201 and second schedule information 202 according to the above embodiment, various parameters may be designated by symbols (a to e) so that various parameters are identified using parameter information 210.

### Variation 2

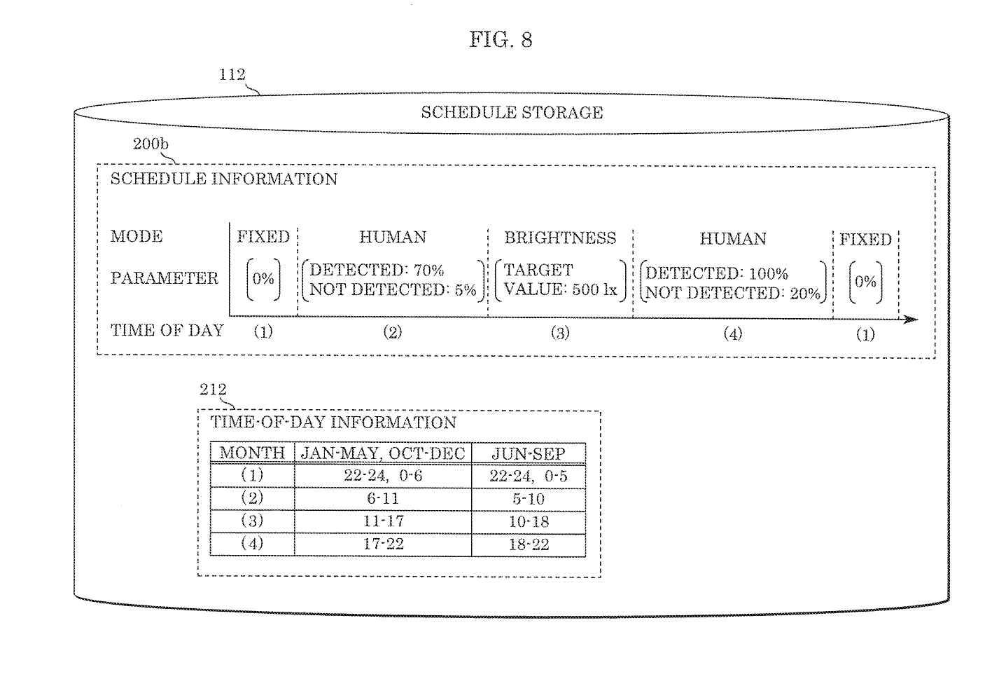

FIG. 8 illustrates an example of schedule information 200b and an example of time-of-day information 212 according to Variation 2 of the embodiment.

Schedule information 200b illustrated in FIG. 8 includes instructions directed to lighting control devices 120, and identifiers ((1) to (4)) associated with the instructions and tied with times. Time-of-day information 212 includes times associated with the identifiers.

Time-of-day information 212 indicates times of day associated with periods and identifiers. Specifically, periods in units of month, such as a period from January through May, are associated with times of day associated with identifiers, such as 22:00 to 24:00, in time-of-day information 212.

In this variation, timer 111 of system control device 110 outputs a time and at least month and day of a date.

Instruction controller 114 of system control device 110 identifies, from time-of-day information 212, an identifier for a period which includes at least one of month and day indicated by a counter value and a time indicated by the counter value.

Instruction controller 114 further identifies, from schedule information 200b, a mode associated with the identified identifier, for instance.

For example, if a counter value output from timer 111 shows “2015.01.30, 10:00”, instruction controller 114 identifies “(2)” which is an identifier corresponding to January and 10:00, from time-of-day information 212.

Instruction controller 114 further identifies, from schedule information 200b, “human detection mode”, “70%”, and “5%”, which are included in an instruction associated with identifier “(2).” Instruction controller 114 causes first communicator 115 to transmit control information 119 which includes the identified instruction (“human detection mode”, “70%”, and “5%”), and one or more addresses associated with schedule information 200b.

Second communicator 125 of each of lighting control devices 120 receives control information 119 transmitted from first communicator 115. As a result, one or more lighting control devices 120 each having an own address that matches one of one or more addresses indicated in control information 119 perform operation as follows. Specifically, dimming controller 124 controls dimming of four lighting devices 150, in accordance with the result of human detection by sensor device 121 (see FIG. 5).

As described above, system control device 110 according to this variation has schedule information 200b which specifies instructions associated with times of day, and time-of-day information 212 which specifies times of day associated with periods. Accordingly, for example, in the case where lighting control devices 120 are each caused to execute a predetermined mode during a predetermined time of day, the predetermined time of day can be changed, extended, or shortened to fall within a range suitable for a season.

For example, time-of-day information 212 illustrated in FIG. 8 defines morning hours (a time of day indicated by identifier (2)) of a period (June to September) which includes summer, one hour earlier than morning hours of other periods (January to May, and October to December).

In other words, by setting morning hours slightly earlier for a period (June to September) when the sun rises comparatively early in a year, lighting control device 120 can control dimming in an appropriate mode that suits a time when a person starts activity, for example.

Note that first schedule information 201 and second schedule information 202 according to the above embodiment may be each configured to refer to times of day specified by time-of-day information 212.

Note that first schedule information 201 and second schedule information 202 according to the above embodiment may each include identifiers ((1) to (4)) so that time-of-day information 212 specifies times of day assigned to various modes.

### Variation 3

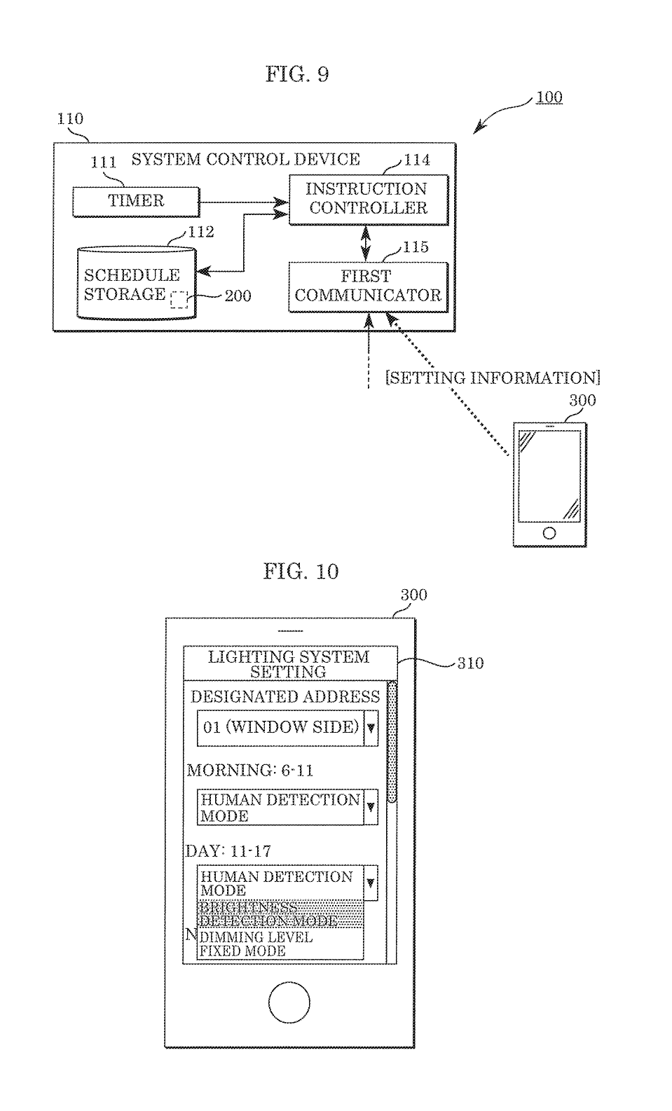

FIG. 9 illustrates system control device 110 and communication terminal 300 according to Variation 3 of the embodiment.

FIG. 10 illustrates an example of a lighting system setting screen displayed on communication terminal 300 according to Variation 3 of the embodiment.

In system control device 110 according to Variation 3 illustrated in FIG. 9, first communicator 115 receives setting information for controlling operation of at least one lighting device 150, which is transmitted from communication terminal 300.

Instruction controller 114 generates or updates schedule information 200, using the setting information received by first communicator 115, and causes schedule storage 112 to store generated or updated schedule information 200.

Communication terminal 300 is a terminal device having an information display function, and can be achieved by a smartphone, a tablet terminal, or a personal computer, for example. Communication terminal 300 has display panel 310, a CPU, a communication interface, and others, and a function of executing an application program.

How information is transmitted and received by communication terminal 300 and first communicator 115 is not particularly limited, and one of various communication standards, such as Wi-Fi (registered trademark) and Bluetooth (registered trademark), is used to transmit and receive information.

The matters with regard to communication terminal 300 described above also apply to Variations 4 and 5 later described.

In this variation, communication terminal 300 is a mobile terminal device typically called a smartphone, and has an application program for setting details of schedule information 200. Communication terminal 300 displays, on display panel 310, for example, a lighting system setting screen (hereinafter, referred to as “setting screen”) as illustrated in FIG. 10, as a user interface.

For example, a user designates an address associated with a schedule for which setting is to be made and modes for times of day via a setting screen, and performs a predetermined operation such as pressing a transmission button displayed on the setting screen, thus transmitting information indicating, for instance, the address and the modes designated via the setting screen, to system control device 110 as setting information. In this variation, setting information is transmitted from communication terminal 300 to system control device 110 through wireless communication.

Note that although FIG. 10 illustrates a screen for a user to select a mode for a fixed time of day such as “morning: 6-11”, the user may make selection or input for items other than modes.

For example, the start and the end of a time of day may be displayed on the setting screen as items that can be selected or input by a user. Furthermore, a set (hereinafter, referred to as a “mode set”) that includes times of day and modes associated with the times of day may be transmitted to system control device 110 as setting information, by a user simply selecting or inputting a setting name such as “summer setting” or “energy saving priority setting.”

Note that communication terminal 300 may transmit, to system control device 110, information indicating a setting name, such as “summer setting” or “energy saving priority setting”, as setting information. In this case, if system control device 110 has stored a mode set corresponding to the setting name, instruction controller 114 can identify a mode set for use in generation or update of schedule information 200, according to the setting name indicated by the setting information.

Accordingly, in this variation, schedule information 200 is generated or updated based on setting information transmitted from communication terminal 300. This allows, for instance, schedule information 200 to be generated with use of, for example, a multifunctional inputter (such as a software/hardware keyboard) included in communication terminal 300.

Thus, efficiency of generation or update of schedule information 200 is increased, and thus schedule information 200 can be readily edited according to a time of day or a season, for example.

### Variation 4

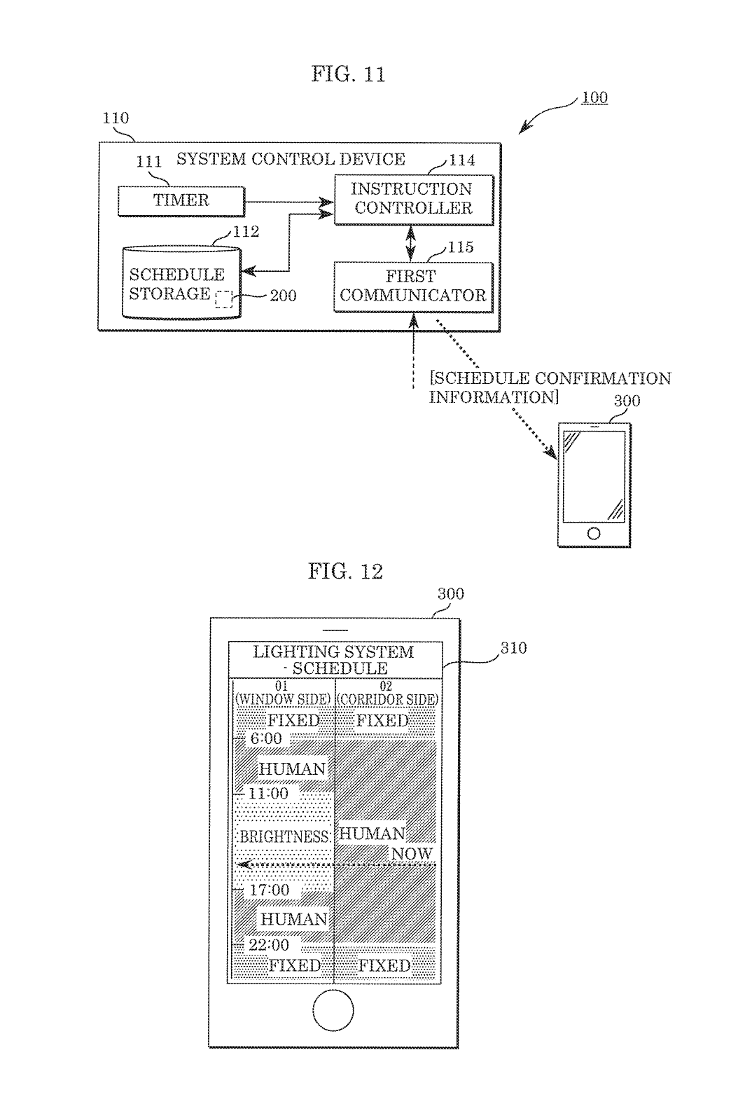

FIG. 11 illustrates system control device 110 and communication terminal 300 according to Variation 4 of the embodiment.

FIG. 12 illustrates an example of a schedule confirmation screen displayed on communication terminal 300 according to Variation 4 of the embodiment.

In system control device 110 according to Variation 4 illustrated in FIG. 11, first communicator 115 transmits at least a part of schedule information 200 stored in schedule storage 112, to communication terminal 300.

In this variation, communication terminal 300 has an application program for requesting schedule confirmation information and generating a schedule confirmation screen, using the received schedule confirmation information.

The user performs a predetermined operation such as pressing a request button displayed after the application program is activated, for example. In this manner, communication terminal 300 transmits, to system control device 110, a request for schedule confirmation information.

If first communicator 115 receives the request, instruction controller 114 reads at least a part of schedule information 200 from schedule storage 112. First communicator 115 transmits the at least one read part to communication terminal 300 as schedule confirmation information.

Note that if a part of schedule information 200 is transmitted as schedule confirmation information, instruction controller 114 may transmit to communication terminal 300, using first communicator 115, a predetermined portion of schedule information 200 on the basis of the current time, for example.

Furthermore, instruction controller 114 may transmit, to communication terminal 300 using first communicator 115, for example, only a portion of schedule information 200 (for example, only first schedule information 201) which is associated with the address designated in a request from communication terminal 300.

In this manner, schedule confirmation information is transmitted from system control device 110 to communication terminal 300, and thus communication terminal 300 can display, on display panel 310, a schedule confirmation screen as illustrated in FIG. 12, for example.

The schedule confirmation screen illustrated in FIG. 12 shows schedules for switching between modes on a single day, which are associated with the addresses, and indicates where in the schedules the current time is at.

In this manner, the user can check with ease which mode is used to control dimming of plural lighting devices 150 throughout the day. Furthermore, the example illustrated in FIG. 12 shows that a user can check which mode is currently used to control dimming of plural lighting devices 150.

This consequently facilitates checking whether the entire schedule which has been set at the point in time is appropriate or whether a dimming control mode being executed at the point in time is appropriate, for example.

Note that although the schedule confirmation screen in FIG. 12 shows text which identifies types of modes such as “human” and “brightness”, these do not need to be expressed by text and, for example, icons associated with such modes may be displayed on the schedule confirmation screen.

Further, the schedule confirmation screen may show parameters used for modes (a dimming level for when a person is detected or a target value of brightness).

Furthermore, for example, a predetermined user operation may switch between and display a schedule associated with address “01” and a schedule associated with address “02”, on the schedule confirmation screen.

First communicator 115 may transmit schedule confirmation information to communication terminal 300, independently of a request from communication terminal 300. First communicator 115 may transmit schedule confirmation information, for example, at regular intervals or upon the occurrence of an event, such as switching between modes (transmission of control information 119), which is a trigger.

### Variation 5

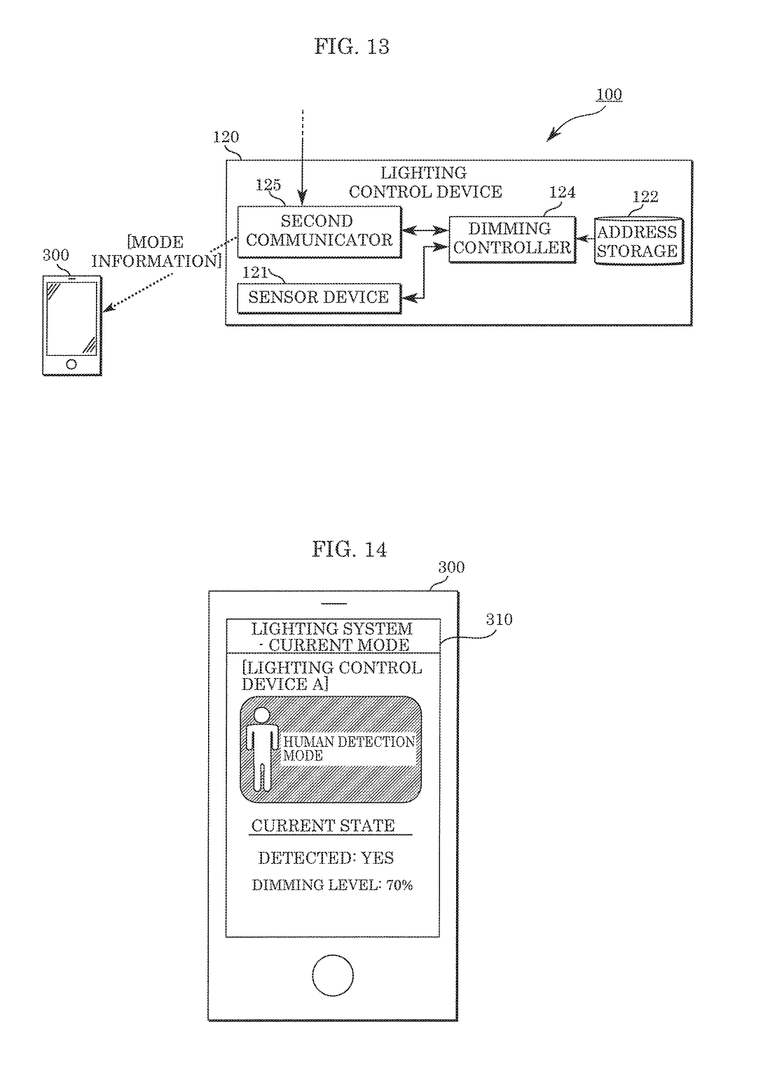

FIG. 13 illustrates lighting control device 120 and communication terminal 300 according to Variation 5 of the embodiment.

FIG. 14 illustrates an example of a mode confirmation screen displayed on communication terminal 300 according to Variation 5 of the embodiment.

Note that although the following describes a mode information transmitting function of lighting control devices 120, not all lighting control devices 120 included in lighting system 100 need to have this mode information transmitting function. Only one of plural lighting control devices 120 may have the mode information transmitting function described in this variation.

Second communicator 125 of lighting control device 120 according to Variation 5 illustrated in FIG. 13 transmits, to communication terminal 300 which communicates with second communicator 125, mode information indicating which mode among the human detection mode, the brightness detection mode, and the dimming level fixed mode dimming controller 124 is executing.

In this variation, communication terminal 300 has an application program for requesting mode information and generating a mode confirmation screen, using the received mode information.

For example, a user performs a predetermined operation such as pressing a request button which is displayed after the application program is activated. In this manner, communication terminal 300 transmits to system control device 110 a request for mode information.

If second communicator 125 receives the request, dimming controller 124 of lighting control device 120 transmits, to communication terminal 300, mode information which indicates a mode that is being executed at the point in time (mode identification information such as a mode name or a mode ID), using second communicator 125. Mode information also includes lighting control device 120.

In this manner, communication terminal 300 which has received the mode information can display a mode confirmation screen as illustrated in FIG. 14 on display panel 310, for example.

The mode confirmation screen illustrated in FIG. 14 shows identification information of lighting control device 120 (“lighting control device A” in this variation), and which mode is currently being executed. Furthermore, this mode confirmation screen shows that the human detection mode is being executed, a person has been detected by this moment, and the dimming level is “70%.” In other words, the mode information transmitted from second communicator 125 includes information such as a dimming level at the time when the request is transmitted.

In this manner, the user can check with ease the type of a current mode being executed by one lighting control device 120 and the details of the mode, thus facilitating checking whether the dimming control mode being executed at the point in time is appropriate.

Note that although the mode confirmation screen illustrated in FIG. 14 shows a current state such as a dimming level as well, communication terminal 300 may output information indicating at least a mode that is being currently executed, based on the received mode information.

Furthermore, system control device 110 may be a transmitter of mode information, rather than lighting control device 120. In other words, system control device 110 includes timer 111 for checking the current time and schedule information 200 which includes an instruction directed to lighting control device 120.

Accordingly, system control device 110 can be indirectly informed of which mode lighting control device 120 having the address is executing, using the address included in a request from communication terminal 300, for example. Accordingly, system control device 110 can transmit, to communication terminal 300, mode information indicating a mode which specific lighting control device 120 is executing.

Specifically, first communicator 115 of system control device 110 may transmit, to communication terminal 300, mode information indicating which mode among the human detection mode, the brightness detection mode, and the dimming level fixed mode dimming controller 124 included in one of plural lighting control devices 120 is executing.

Note that first communicator 115 or second communicator 125 may transmit mode information to communication terminal 300, independently of a request from communication terminal 300. First communicator 115 or second communicator 125 may transmit mode information at regular intervals, for example.

Furthermore, for example, second communicator 125 may transmit mode information upon a change in a dimming level in a certain mode or the occurrence of an event such as switching between modes, which is a trigger.

### Variation 6

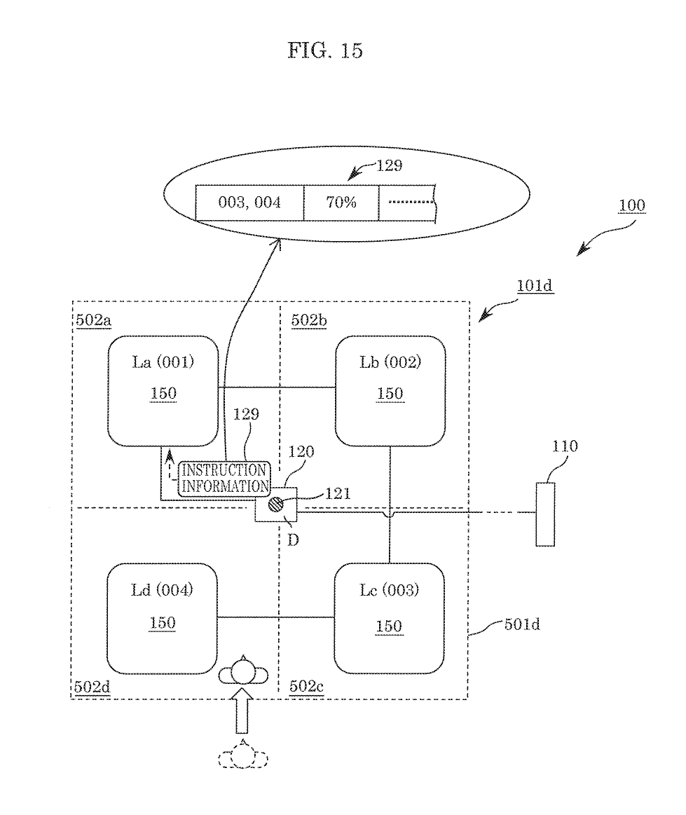

FIG. 15 illustrates a flow of instruction information 129 in subsystem 101d according to Variation 5 of the embodiment.

Note that although the following describes an individual control function of one subsystem (subsystem 101d) to control plural lighting devices 150 separately, plural subsystems may have the individual control function. For example, all subsystems 101a to 101d may have the individual control function.

Subsystem 101d according to this variation includes lighting control device 120 (lighting control device D in this variation), and plural lighting devices 150 (La to Ld) each having an assigned device address and connected to lighting control device 120. In this variation, different device addresses (001 to 004) are assigned to plural lighting devices 150 (La to Ld).

Dimming controller 124 of lighting control device 120 transmits, to plural lighting devices 150, instruction information 129 which includes at least one device address among the device addresses and information indicating a dimming level. In this manner, dimming of at least one lighting device 150 having the at least one device address is controlled.

Specifically, in subsystem 101d according to this variation, lighting circuit 152 included in each of plural lighting devices 150 receives instruction information 129 transmitted from lighting control device 120. When the at least one device address indicated in instruction information 129 includes the device address of lighting device 150 among lighting devices 150, lighting circuit 152 of lighting device 150 causes light source 155 of lighting device 150 to provide illumination at the dimming level indicated by instruction information 129.

In the example illustrated in FIG. 15, instruction information 129 includes two destination device addresses “003” and “004”, and “70%” indicating a dimming level.

In this case, four lighting devices 150 receive instruction information 129 transmitted from lighting control device 120. However, lighting device 150 (lighting device La) to which address “001” is assigned and lighting device 150 (lighting device Lb) to which address “002” is assigned ignore the instruction indicated in instruction information 129, because the destination device addresses do not include the device addresses of lighting devices La and Lb.

In contrast, lighting device 150 (lighting device Lc) to which device address “003” is assigned and lighting device 150 (lighting device Ld) to which device address “004” is assigned execute the instruction indicated in instruction information 129, because the destination device addresses include the device addresses of lighting devices Lc and Ld.

As a result, for example, the dimming level of lighting devices La and Lb is not changed, while the dimming level of lighting devices Lc and Ld is changed to “70%.”

As described above, lighting control device 120 can control dimming of plural lighting devices 150 differently from one another.

This feature is useful in scenes as follows, for example. Now, assume the case where a person enters subregion 501d in which no person was present, as illustrated in FIG. 15, during a period when lighting control device 120 is executing the human detection mode.

In the assumed case, subregion 501d where subsystem 101d is disposed is divided into four individual regions (502a to 502d) as illustrated in FIG. 15, and sensor device 121 detects a person in and brightness of each of the individual regions (502a to 502d).

In this state, four lighting devices 150 provide illumination at a dimming level of “5%” before a person enters subregion 501d. Later, sensor device 121 detects the presence of the person in individual region 502d. Dimming controller 124 causes second communicator 125 to transmit instruction information 129 for changing the dimming level of lighting devices Ld and Lc which illuminate individual regions 502d and 502c to “70%”, based on the detection result.

In other words, instruction information 129 illustrated in FIG. 15, whose destination device addresses are lighting devices Ld and Lc, is transmitted to four lighting devices 150, and only lighting devices Ld and Lc, among four lighting devices 150, cause light sources 155 to provide illumination at a dimming level of “70%”, in accordance with instruction information 129.

As a result, a predetermined area of subregion 501d which includes a position where the person is present is brightly illuminated, and the dimming level of one or more lighting devices 150 in other areas is maintained low. This achieves a partial increase in the brightness of illumination region 500 if necessary, and furthermore saves power consumption of entire lighting system 100.

Note that in the example illustrated in FIG. 15, dimming may be controlled to change the dimming level of only lighting device Ld in individual region 502d where the person is detected to “70%”, among four individual regions (502a to 502d).

Furthermore, different device addresses are not necessarily assigned to lighting devices La to Ld. For example, the same device address may be assigned to two or more lighting devices 150 for which dimming control for the same mode needs to be performed in synchronization.

For example, in the brightness detection mode, dimming controller 124 can also give an instruction indicating different dimming levels to four lighting devices 150, based on the detection results of brightness of four individual regions (502a to 502d) obtained by sensor device 121. In this manner, for example, the brightness of the individual regions can be equalized although the individual regions are under different conditions such as how much natural light comes in.

### OTHER EMBODIMENTS

Although the above has described lighting devices based on an embodiment and variations thereof, the lighting devices are not limited to the embodiment and the variations.

For example, in FIG. 4, schedule information 200 includes first schedule information 201 and second schedule information 202 which clearly show schedules associated with two addresses “01” and “02”, respectively.

However, aspects of schedule information 200 are not limited to the above described aspect. For example, schedule information 200 may have information indicating associations of instructions and times, which is used in common by four lighting control devices 120 according to the embodiment described above.

In this case, instruction controller 114 may operate in accordance with a rule specifying that transmission of an instruction to address “02” is prevented during a period from 6:00 to 21:00, for example. In this case, only “01” is designated as a destination address of an instruction given during the period from 6:00 to 21:00 and indicated in schedule information 200. As a result, lighting control devices 120 (A and B) having address “01” and lighting control devices 120 (C and D) having address “02” can be caused to execute different modes during the same time of day.

For example, if schedule information 200 indicates when to switch between modes in units of time, the time indicated by a counter value output from timer 111 may indicate at least hour of the time including hour, minute, and second.

Furthermore, schedule information 200 does not need to include parameters as illustrated in FIG. 4, for example. Assume an example of the case where lighting control device 120 stores parameters such as dimming levels or target illuminance for when a person is detected and for when no person is detected. In this case, if lighting control device 120 receives information for identifying a mode to be executed from system control device 110, lighting control device 120 can execute the mode using one or more parameters suitable for the mode.

In the human detection mode, a dimming level may be changed to three levels or more, for example. For example, if many people are detected, control for increasing the dimming level may be performed. Furthermore, if sensor device 121 detects a person in the human detection mode, sensor device 121 may output a detection result which indicates the state of the detected person. For example, if sensor device 121 detects a person, sensor device 121 may output a detection result that is more specifically classified, such as a detection result indicating that the detected person is not moving or is moving.

In this case, dimming controller 124 may control dimming using different dimming levels when the detection result output from sensor device 121 indicates that the detected person is moving and that the detected person is not moving. Further, system control device 110 may transmit such dimming levels to lighting control device 120.

In other words, if the instruction identified from schedule information 200 shows the human detection mode, instruction controller 114 of system control device 110 may cause first communicator 115 to transmit control information 119 which includes a parameter indicating a dimming level based on a state of a person when he/she is detected or a dimming level for when no person is detected.

Separate storage devices may store schedule information 200 and other information, such as parameter information 210 and time-of-day information 212.

A parameter such as a dimming level for each mode and a time of day assigned to each mode may be both arbitrarily determined in a schedule of dimming control which is to be executed by lighting control device 120. In other words, lighting system 100 may have features of both Variations 1 and 2.

Furthermore, an instruction given from system control device 110 and directed to lighting control device 120 may not explicitly show a mode to be executed by lighting control device 120. For example, if control information 119 includes information indicating that a target value is “500 lx”, lighting control device 120 can determine that the brightness detection mode is to be executed. Similarly, if control information 119 includes information indicating two dimming levels, lighting control device 120 can determine that the human detection mode is to be executed. Furthermore, if control information 119 includes only one dimming level, lighting control device 120 can determine that the dimming level fixed mode is to be executed.

Light source 155 included in lighting device 150 may not include one or more LEDs. For example, one or more fluorescence tubes may be employed as light source 155. Furthermore, light emitting elements, such as semiconductor light emitting elements including a semiconductor laser, organic electroluminescence (EL), and inorganic EL, may be employed as light source 155.

Further, the present disclosure can be achieved as a program for causing a computer to execute distinctive processing that is performed by at least one of system control device 110 and lighting control device 120. Such a program can be distributed via a recording medium such as CD-ROM and a transmission medium such as the Internet.

The present disclosure may also include embodiments as a result of adding, to the embodiments, various modifications that may be conceived by those skilled in the art, and embodiments obtained by combining constituent elements and functions in the embodiments in any manner without departing from the spirit of the present disclosure.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A lighting system comprising:
a plurality of lighting devices each including a light source and a lighting circuit which causes the light source to provide illumination;
a plurality of lighting controllers each of which controls dimming of one or more lighting devices among the plurality of lighting devices by controlling the lighting circuit included in each of the one or more lighting devices; and
a system controller which controls the plurality of lighting controllers,
the system controller including:
a timer which outputs a counter value indicating a time;
a schedule storage for storing schedule information which includes an instruction directed to the plurality of lighting controllers and a time associated with the instruction;
a first communication circuit which transmits information to the plurality of lighting controllers; and
an instruction controller which identifies, from the schedule information, an instruction associated with the time indicated by the counter value, and causes the first communication circuit to transmit control information which includes the identified instruction and an address assigned to at least one lighting controller among the plurality of lighting controllers,
each of the plurality of lighting controllers including:
a sensor which detects (i) a person in a space where the one or more lighting devices, the dimming of which is controlled by the each of the plurality of lighting controllers, are disposed, and (ii) brightness of the space;
a second communication circuit which receives the control information transmitted from the system controller;
an address storage which stores an own address of the each of the plurality of lighting controllers that is an address assigned to the each of the plurality of lighting controllers; and
a dimming controller which switches to one of modes that is indicated in the control information from another of the modes and executes the one of the modes, if the address indicated in the control information received by the second communication circuit matches the own address, the modes including (a) a human detection mode for controlling the dimming in accordance with a result of human detection by the sensor, (b) a brightness detection mode for controlling the dimming in accordance with a result of detection of the brightness by the sensor, and (c) a dimming level fixed mode for controlling the dimming by maintaining a dimming level at a fixed value.

2. The lighting system according to claim 1, wherein:
the schedule information includes:
first schedule information which includes an instruction directed to a first lighting controller among the plurality of lighting controllers, and a time associated with the instruction; and
second schedule information which includes an instruction directed to, among the plurality of lighting controllers, a second lighting controller to which an address different from an address assigned to the first lighting controller is assigned, and a time associated with the instruction,
when the instruction controller identifies, from the first schedule information, an instruction associated with the time indicated by the counter value, the control information which the instruction controller causes the first communication circuit to transmit includes the identified instruction and the address assigned to the first lighting controller, and
when the instruction controller identifies, from the second schedule information, an instruction associated with the time indicated by the counter value, the control information which the instruction controller causes the first communication circuit to transmit includes the identified instruction, and the address assigned to the second lighting controller.

3. The lighting system according to claim 1, wherein:
when the identified instruction indicates the human detection mode, the instruction controller causes the first communication circuit to transmit the control information which includes a parameter indicating one of a dimming level based on a state of a person when the person is detected and a dimming level for when no person is detected, and
when the address indicated in the control information matches the own address of a lighting controller among the plurality of lighting controllers and the control information indicates the human detection mode, the dimming controller of the lighting controller controls the dimming using the dimming level indicated by the parameter.

4. The lighting system according to claim 1, wherein:
when the identified instruction indicates the brightness detection mode, the instruction controller causes the first communication circuit to transmit the control information which includes a parameter indicating a target value representing target brightness, and
when the address indicated in the control information matches the own address of a lighting controller among the plurality of lighting controllers and the control information indicates the brightness detection mode, the dimming controller of the lighting controller controls the dimming to make the brightness which is detected by the sensor approximate to the target value indicated by the parameter.

5. The lighting system according to claim 3, wherein:
the counter value output by the timer indicates at least month and day of a date, in addition to the time,
the schedule storage further stores parameter information indicating a plurality of the parameters associated with periods, and
the instruction controller reads, from among the plurality of parameters indicated by the parameter information, a parameter associated with a period which includes at least one of the month and the day indicated by the counter value, and causes the first communication circuit to transmit the control information which includes the read parameter.

6. The lighting system according to claim 1, wherein:
the schedule information further includes an identifier tied with the time and associated with the instruction directed to the plurality of lighting controllers,
the counter value output by the timer indicates at least month and day of a date, in addition to the time,
the schedule storage further stores time-of-day information indicating times of day associated with periods and identifiers including the identifier, and
the instruction controller reads, from among the identifiers in the time-of-day information, an identifier corresponding to (i) a period which includes at least one of the month and the day indicated by the counter value and (ii) the time indicated by the counter value, and identifies, from the schedule information, an instruction associated with the read identifier.

7. The lighting system according to claim 1, wherein:
the plurality of lighting controllers include a first lighting controller connected to, among the plurality of lighting devices, two or more lighting devices having assigned device addresses,
the dimming controller included in the first lighting controller connected to the two or more lighting devices transmits, to the two or more lighting devices, instruction information which includes at least one device address among the assigned device addresses and information indicating a dimming level, to control the dimming of at least one lighting device having the at least one device address, among the two or more lighting devices,
the lighting circuit of each of the two or more lighting devices receives the instruction information, and
when the at least one device address indicated in the instruction information includes the device address of a lighting device among the two or more lighting devices, the lighting circuit of the lighting device causes the light source of the lighting device to provide illumination at the dimming level indicated in the instruction information.

8. A lighting system comprising:
a plurality of lighting devices each including a light source and a lighting circuit which causes the light source to provide illumination;
a plurality of lighting controllers each of which controls dimming of one or more lighting devices among the plurality of lighting devices by controlling the lighting circuit included in each of the one or more lighting devices; and
a system controller which controls the plurality of lighting controllers,
the system controller including:
a timer which outputs a counter value indicating a time;
a schedule storage for storing schedule information which includes an instruction directed to the plurality of lighting controllers and a time associated with the instruction;
a first communication circuit which transmits information to the plurality of lighting controllers; and
an instruction controller which identifies, from the schedule information, an instruction associated with the time indicated by the counter value, and causes the first communication circuit to transmit control information which includes the identified instruction and an address assigned to at least one lighting controller among the plurality of lighting controllers,
each of the plurality of lighting controllers including:
a sensor which detects (i) a person in a space where the one or more lighting devices, the dimming of which is controlled by the each of the plurality of lighting controllers, are disposed, and (ii) brightness of the space;
a second communication circuit which receives the control information transmitted from the system controller;
an address storage which stores an own address of the each of the plurality of lighting controllers that is an address assigned to the each of the plurality of lighting controllers; and
a dimming controller which switches to one of modes that is indicated in the control information from another of the modes and executes the one of the modes, if the address indicated in the control information received by the second communication circuit matches the own address, the modes including (a) a human detection mode for controlling the dimming in accordance with a result of human detection by the sensor, (b) a brightness detection mode for controlling the dimming in accordance with a result of detection of the brightness by the sensor, and (c) a dimming level fixed mode for controlling the dimming by maintaining a dimming level at a fixed value, wherein:
the first communication circuit further receives setting information for controlling operation of at least one of the plurality of lighting devices, which is transmitted from a communication terminal, and
the instruction controller further generates or updates the schedule information, using the setting information received by the first communication circuit, and causes the schedule storage to store the generated or updated schedule information.

9. The lighting system according to claim 8, wherein
the first communication circuit further transmits at least a part of the schedule information stored in the schedule storage to the communication terminal.

10. The lighting system according to claim 8, wherein
the second communication circuit included in one of the plurality of lighting controllers further transmits, to the communication terminal, mode information indicating which mode among the human detection mode, the brightness detection mode, and the dimming level fixed mode the dimming controller included in the one of the lighting controllers is executing.

11. A method for controlling a lighting system which includes: a plurality of lighting controllers each of which controls dimming of one or more lighting devices; and a system controller which controls the plurality of lighting controllers,
the system controller including: a timer which outputs a counter value indicating a time; and a schedule storage for storing schedule information which includes an instruction directed to the plurality of lighting controllers and a time associated with the instruction,
each of the plurality of lighting controllers including: an address storage which stores an own address of the each of the plurality of lighting controllers that is an address assigned to the each of the plurality of lighting controllers; and a sensor which detects a person in a space where the one or more lighting devices are disposed, and brightness of the space,
the method comprising:
identifying, by the system controller from the schedule information, an instruction associated with the time indicated by the counter value;
transmitting, to the plurality of lighting controllers by the system controller, control information which includes the identified instruction and an address assigned to at least one lighting controller among the plurality of lighting controllers;
receiving, by each of the plurality of lighting controllers, the control information transmitted from the system controller; and
switching, by each of the plurality of lighting controllers, to one of modes that is indicated in the control information from another of the modes, and executing, by the lighting controller, the one of the modes, if the address indicated in the control information matches the own address, the modes including (a) a human detection mode for controlling the dimming in accordance with a result of human detection by the sensor, (b) a brightness detection mode for controlling the dimming in accordance with a result of detection of the brightness by the sensor, and (c) a dimming level fixed mode for controlling the dimming by maintaining a dimming level at a fixed value.

12. A lighting system comprising:
a plurality of lighting controllers each of which controls dimming of one or more lighting devices, and includes a light source and a lighting circuit; and
a system controller which controls the plurality of lighting controllers,
each of the plurality of lighting controllers including:
a sensor which detects (i) a person in a space where the one or more lighting devices to be controlled are disposed, and (ii) brightness of the space; and
a dimming controller which switches to one of modes from another of the modes and executes the one of the modes, based on control information transmitted from the system controller and a detection result by the sensor, the modes including (a) a human detection mode for controlling the dimming in accordance with a result of human detection by the sensor, (b) a brightness detection mode for controlling the dimming in accordance with a result of detection of the brightness by the sensor, and (c) a dimming level fixed mode for controlling the dimming by maintaining a dimming level at a fixed value.
